(19) United States
(12) Patent Application Publication
(10) Pub. No.: US 2002/0082928 A1
(43) Pub. Date: Jun. 27, 2002

(54) METHOD OF CONSTRUCTING A DATABASE FOR MANAGING MANUFACTURING ENGINEERING INFORMATION, RECORDING MEDIUM RECORDING PROGRAM THEREOF, AND SYSTEM THEREFOR

(76) Inventors: KIMINOBU KODAMA, KAWASAKI (JP); MASAO TOMONO, TOKYO (JP); AYUMI TESHIMA, CHIGASAKI (JP)

Correspondence Address: FRISHAUF HOLTZ GOODMAN LANGER AND CHICK PC, 767 THIRD AVENUE 25TH FLOOR, NEW YORK, NY, 10017-2023, US

(21) Appl. No.: 09/448,055

(22) Filed: Nov. 23, 1999

(30) Foreign Application Priority Data
Mar. 11, 1999 (JP) 11-065449

(51) Int. Cl. G06G 1/14

(52) U.S. Cl. 705/22

(57) ABSTRACT

A database for managing manufacturing engineering information is constructed by defining a set of products having a collection of attributes of use which are arbitrarily predetermined as a series product, and by defining each product contained in the series product by a collection of values of the attributes of use. A recording medium is provided for recording a program for achieving such a method, and a system is provided for carrying out the method. As a result, the data volume of the database may be reduced, and the retrieval of similar products and similar manufacturing processes may be simplified.

### BACKGROUND OF THE INVENTION

1. Field of the Invention

The present invention relates to a method of constructing a database for managing manufacturing engineering information such as product configuration information, a recording medium recording a program thereof, and a system therefor.

2. Description of Related Art

In the manufacturing sectors of industry, improvement of productivity has been and is attempted by managing engineering information such as configuration of products and parts. As one of the methods of such manufacturing engineering information control, there is available a method of integrating the product configuration including intermediate product and parts up to the final product into a database in the form of a bill of material.

This database is expressed in the form of a parent/children relationship with the produced item (for example, a product, a work-in-process) as a parent, and input items (for example, parts and works-in-process) as children. The individual manufacturing routings for manufacturing the produced items are expressed in a separately prepared manufacturing routing table. Manufacturing engineering information is controlled by combining the bill of material and the manufacturing routing table.

In the conventional database configuration as described above, however, input items have to be configured for each produced item. For only a slight change in input items composing the produced item, therefore, it is necessary to set another produced item, and duplications of input items tend to increase as the difference in configuration between produced items decreases. When there are many produced items having slight differences, therefore, there is an explosive increase in configuration information (i.e., in the number of input items). As a result, when specifications are changed because of the development of a product or parts, influence is exerted on a wide range covering input items composing the product or the parts or the produced items using such products as input items thereof, thus resulting in more complicated works to cope with.

To avoid the adverse effects over a wide range as described above, therefore, it has been tried to treat products and parts associated with changes in specifications as to special order items, without registering them in the database (bill of material). In this case, however, retrieval as a product could not reach a corresponding one, and in spite of development efforts, products of the same functions or of the same quality have often been developed in duplication.

The conventional database configuration further has the following problems. Even for a product which could otherwise be manufactured only by combining already defined manufacturing engineering information, similar products cannot be retrieved since each produced item is independently configured. A manufacturing process cannot be retrieved because the bill of materials and the manufacturing routing table are separately defined, thus requiring a duplicate development and redefining of the manufacturing engineering information. Upon working out a production plan, therefore, it becomes difficult to produce a product by combining similar parts, thus preventing a mass-production effect from fully displaying the merits thereof. Results of finite loading adjustment cannot be reflected in the material procuring schedule. Productivity cannot therefore be improved, and moreover, this may often lead to equipment laying idle.

### SUMMARY OF THE INVENTION

The present invention was developed to solve the aforementioned problems, and has an objective to provide a method of constructing a database for managing manufacturing engineering information which permits reduction of the data volume and easy retrieval of similar products and similar manufacturing processes, a recording medium recording a program thereof, and a system therefor.

The above-mentioned objective can be achieved by a method of constructing a database for managing manufacturing engineering information comprising:

defining a set of products having a collection of attributes of use which are arbitrarily predetermined as a series product; and

defining each product contained in said series product by a collection of values of said attributes of use.

In the present invention, arbitrary products (series products) are conceived with a view to making it possible to continue to make products so as to satisfy demands from individual customers while maintaining operating rate and productivity as in mass-production (mass-customization). Accordingly, each product is conceived as being definable by setting forth concrete values (attribute values) for one or more kinds of attributes of use (attribute types) in addition to basic specifications of those series products. Thus, the product is not represented by a collection of component parts, but by a set of attribute values for each product of that series product.

If a manufacturing process of a product is conceived as a modification (addition, deletion, replacement or selection) of a sequence of activities common to the series product to which the product in question belongs for achieving attribute values of that product, the manufacturing process of the product can be derived by using activities as members in the manufacturing steps for achieving the individual attribute values of the products, and arranging the activities in a prescribed sequence.

Information about all parts composing the product is available by recursively repeating the steps of retrieving parts used in the activities applied during the manufacturing steps on the basis of the manufacturing process of the product, and deriving the manufacturing process of the product with that part as a new product.

Also according to the present invention, by-products which are produced by manufacturing series activities, excluding works-in-process produced by the manufacturing series activities, may be represented using a set of values of attributes of use. Such by-products can then be managed as products. By the application of this method, it is possible to effectively manage and use by-products as resources.

The method of constructing a database for managing product engineering information of the present invention, moreover, may be achieved by a computer program comprising:

program code means for enabling a computer to define a set of products having a collection of attributes of use which are arbitrarily predetermined as a series product; and

program code means for defining each product contained in the series product by a collection of values of the attributes of use. Such a computer program may be stored on a recording medium.

Still further, the method of constructing a database for managing product engineering information of the invention can be achieved by the use of a manufacturing engineering information management system comprising:

attribute value storing means storing values of attributes of use which are arbitrarily predetermined, and a set of products having a collection of said attributes of use;

activity storing means for storing activities which may be applied to achieve said values of said attributes of use, as well as time and physical resource data required by said activities; and

manufacturing engineering information management means for managing a manufacturing process of a particular product of the set of products based on said stored activities, and for managing parts or manufacturing steps of said particular product based on said stored time and physical resource data required for said activities.

### BRIEF DESCRIPTION OF THE DRAWINGS

FIG. 1 illustrates a conceptual instance model showing an embodiment of the method of constructing a database for managing manufacturing engineering information of the present invention;

FIG. 2 is a descriptive view of the concept of the series product and the product;

FIG. 3 illustrates the relationship between input parts and a product in the method of the invention;

FIGS. 4a-4f illustrate the relationship between input parts and a product in the method of the conventional art; and

FIG. 5 illustrates a conceptual object model representing the method of the invention using UML (Unified Modeling Language) notation.

FIG. 6 illustrates a schematic block diagram of a user interface and program for inputting data into a database having the configuration set forth in FIG. 5.

FIG. 7 illustrates a schematic block diagram of a manufacturing engineering information management system according to the invention.

### DESCRIPTION OF THE PREFERRED EMBODIMENTS

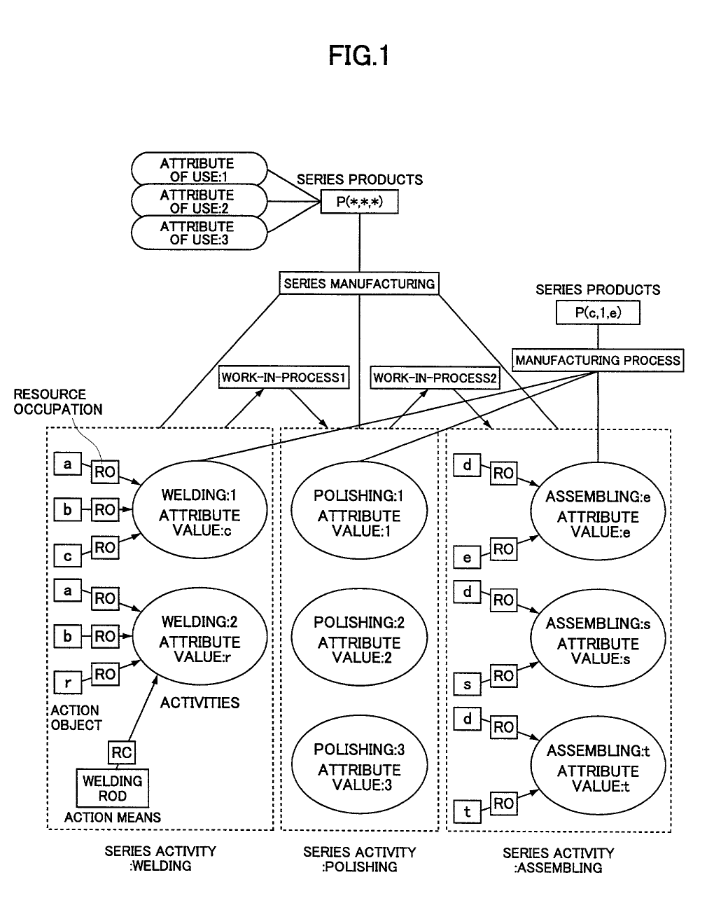

FIG. 1 illustrates a conceptual instance model showing an embodiment of the method of constructing a database for managing manufacturing engineering information of the invention. Manufacturing management based on this conceptual model is made applicable by arithmetic control means such as a computer and a program causing such an arithmetic control means to perform operations as described below. Data necessary for building this program and this conceptual model are recorded in a recording medium such as a hard disk or a semiconductor memory.

In FIG. 1, the concept of a set of products having common specifications and identifiable with a collection of kinds of attributes of use such as a shape is herein defined as a series product P. In this embodiment, the products of the series product P are assumed to have, in addition to common specifications, three attribute types including shape (attribute of use 1), grain (attribute of use 2) and function (attribute of use 3).

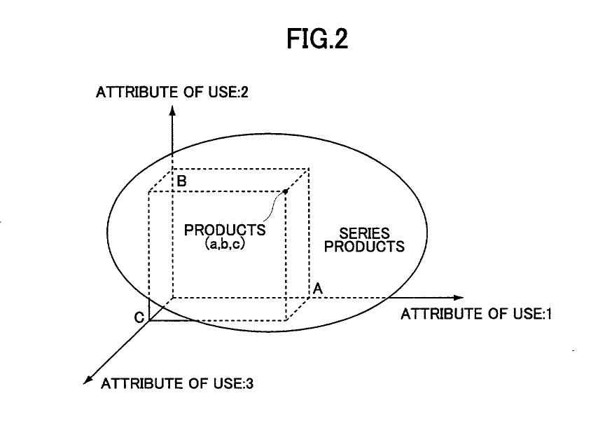

FIG. 2 is a descriptive view of the concept of series product and product.

A series product is herein assumed to have the three attribute types. When considering the coordinate system taking the individual attribute types as orders, the series product in the invention is represented by a collection of points on a three-dimensional space. Each point present in this space therefore corresponds to each product. The concrete attribute of each attribute type is represented as a value (regarding the shape, for example, a value is assigned) which is used as an attribute value. A different product means that the attribute value of at least one attribute type is different. An attribute value, moreover, may be different, not only when the component parts of the product are different, but also when the component parts are not different.

Development of a new product is understood as an exploration within such a space. In practice, the number of attribute types within a series product should be within a range of from 10 to 20 (when there are 20 attribute types, the system would be of the 20th order). That is, even when an attribute type has only two attribute values, it is possible to handle 2¹⁰ to 2²⁰ kinds of products.

An operation of realizing 0 or more attributes of use is herein referred to as a series product activity (hereinafter referred to as a “series activities”). The sequence of series activities incidental to a series product (series manufacturing) manages the sequence of the activities in the manufacturing process. Activities are set as operations for realizing 0 or more attribute values, and the series product, the series activities and the activities are registered in a database for engineering information. At this point, the manufacturing process of the product P (a, b, c) is represented by a sequenced collection in which the sequence of the activities capable of achieving the attribute values a, b and c is replaced by the sequence of the series activities of the series product P (*, *, *). The attribute values of the product may partially be left undetermined. In this case, the manufacturing process is derived by the use of default values. This method is effective when the attribute values to be realized are set forth late in the sequence.

In this embodiment, three series activities including welding, polishing and assembling are assumed as shown in FIG. 1. Welding comprises concrete activities of welding 1 and welding 2. Polishing comprises activities of polishing 1, polishing 2 and polishing 3. Assembling comprises activities of assembling e, assembling s and assembling t.

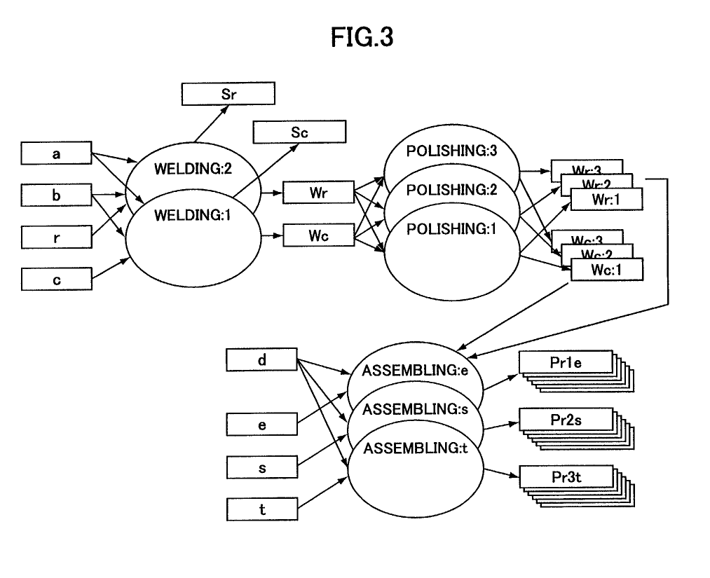

FIG. 3 illustrates the relationship between input parts of a product and the manufacturing process. Applying three series activities of welding, polishing and assembling is referred to as the series product manufacturing process of the series product P. For example, action (i.e., a manufacturing step) is applied so as to achieve a cubic shape in welding 1, and a spherical shape in welding 2. This action permits achievement of the attribute of use 1 (shape). Part a and part b are input as common parts (to a welding station 1 and/or to a welding station 2) upon action of welding 1 or welding 2. Upon action of welding 1, part c is additionally input as an optional part at welding 1, as shown in FIG. 3. Similarly, upon action of welding 2, part r is input as an optional part. As a result, Wr is produced as a work-in-process (intermediate product) in welding 1, and Wc is produced as a work-in-process in welding 2. In a method of configuration such as that for this database, it is not necessary to register Wr or Wc, which is automatically synthesized.

Upon welding 1 and welding 2, a by-product Sc or Sr is assumed to be produced apart from Wr or Wc produced as a work-in-process of product P. A by-product means chips other than a work-in-process produced through cutting, for instance, or a gas having a calorific value resulting from generated heat when, for example, there is a series activity of cutting. These by-products, which are not necessary for the manufacture of product P, can however be important resources from the other points of view, and can be utilized in dependent or other products. When disassembling a product, moreover, the disassembled product which is an instance of the series activities of disassembling is deemed as a new product and can be handled as such. Such a new product is therefore managed with the database as a by-product.

The work-in-process Wr or Wc produced by welding 1 and welding 2 is input upon action of polishing 1, polishing 2 or polishing 3. The attribute of use 2 (grain) is achieved by this action. As a result, Wr 1 or Wc 1 is produced in polishing 1, or Wc 2, in polishing 2, and Wr 3 or Wc 3, in polishing 3, as work-in-process, as shown in FIG. 3.

In assembly, part d is input as a common part upon action of assembling e, assembling s or assembling t. Part e is further optionally input upon action of assembling e, part s, upon action of assembling s, and part t, upon action of assembling t. This action achieves the attribute of use 3 (function). By the addition of such optional parts and variation of activities, it is possible to register similar products while reducing duplicate registration of parts. In this embodiment, up to 18 (2×3×3) kinds of product are retained finally as product information.

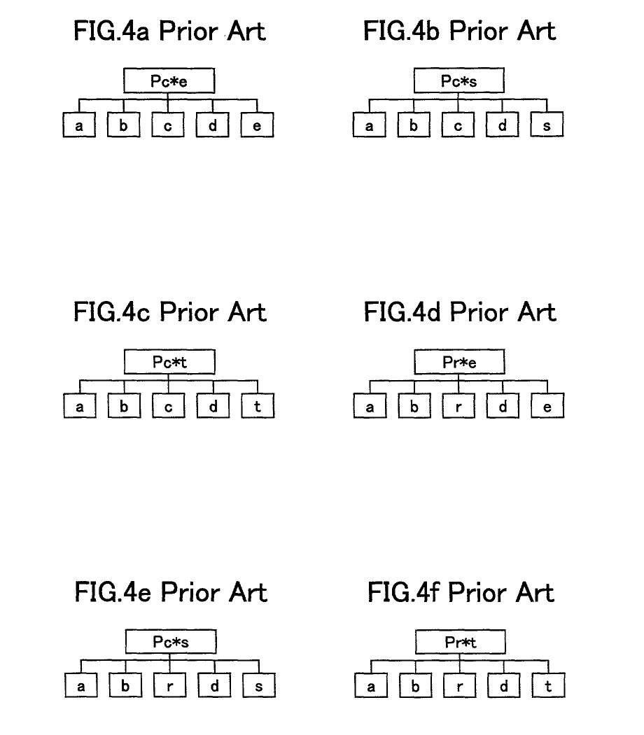

FIGS. 4a-4f illustrate the relationships between input parts and a product in the method of the conventional art. In the conventional method, as described above, this is represented in the form of parent-children relationship with a produced item as a parent and input items as children. Therefore, a produced item (product in this case) is basically represented only by a combination of input items (parts in this case), and a difference in product results in differences in parts. In FIGS. 4a-4f, six kinds of products are defined by means of differences in component parts.

However, when, for example, there is a difference in grain resulting from polishing, the difference in product cannot be defined in terms of parts, because the difference in precision is not caused by parts. If this is to be defined, conventionally, the only choice has been to represent three produced items having the same input items (parts), and assign them to the differences caused by polishing. As a result, there would be defined 2×3×3=18 kinds of product, with, however, numerous duplications of parts. This leads to redundant operations. In addition, when preparing configuration information for a work-in-process, it is necessary to define the configuration with the work-in-process as a parent. In such a case, the method of constructing a database for managing manufacturing engineering information of the invention is effective.

In FIG. 1, the series manufacturing methods of the series product P (*,*,*) are prescribed to be carried out in a sequence of series activities from welding to polishing and then assembling. More specifically, a product is defined in the form of, for example, P(c,l,e), where c, l and e are attribute values of the attribute types defined by welding, polishing and assembling, respectively. The attribute value c is achieved by the activity of welding 1, the attribute value 1, by the activity of polishing 1, and the attribute value e, by the activity of assembling e. Therefore, (welding 1, polishing 1, assembling e) which is a sequenced collection of a series of activities for realizing product P(c,l,e) is derived as a manufacturing process. In this case, the part configuration (input items) of product P(c,l,e) would be a collection of parts input into the entire manufacturing process and is defined as (part a, part b, part c, part d and part e).

Although not shown in FIG. 1, if the part a is assumed to be manufactured in another lower stream process, a series product A having the part a as a product is set in advance. In this connection, it is noted that the part a, being a simple component part relative to the products of the series product P, is a product as viewed from the series product A. Activities or a manufacturing process corresponding to the producing part a are derived from the set of attribute values of the part a corresponding to the attribute types of the series product A. As a result, there is available a configuration of parts necessary for manufacturing the part a. This technique is also applicable for the other parts or component parts used to produce product P.

Derivation of activities for realizing attribute values of a product A will now be considered. In order to derive activities, in general, attribute values to be achieved by the activities must be determined. For some activities, however, all the attribute values have not always been determined. In this case, special values called specified values are used in place of the attribute values. When assuming an activity 1, if the remaining attribute values realized by the activity 1 correspond to the attribute values of the product A, the activity taking the place of the specified value of the activity 1 with the same attribute types from among the attribute values of the product A is referred to as the activity 1′, thereby deriving it as the activity for materializing the attribute values of the product A. When attribute values have not as yet been determined for some of the products of the series product, a special value called a default value is used in place of the attribute value. For example, when a part “a” used in the activities 1 (i.e., welding 1) for achieving attribute values of a product contains a default value, the attribute values of the activity 1′ is replaced by the default value, thereby deriving activities or a manufacturing process as attribute values of the part a, and obtaining a configuration of parts.

As described above, explosion of parts for a product is accomplished by deriving manufacturing processes of parts in stages from upper to lower orders, and repeating recursive derivation for sets of component parts input.

For example, a manufacturing process of a product is derived from attribute values and activities for materializing the same, and component parts are obtained. A component part is obtained by deriving a manufacturing process of a component part from the attribute value of a component part and the activity for achieving the same. By repeating this operation, it is possible to obtain data of all the component parts for manufacturing a product.

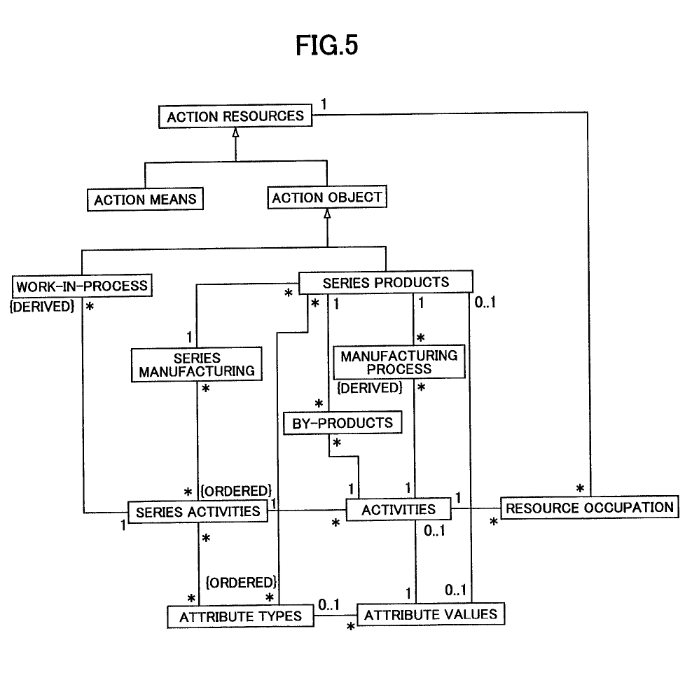

FIG. 5 illustrates a conceptual object model representing the method of the invention using UML (Unified Modeling Language) notation. In this model, items including the series product, attribute types, attribute value, series manufacturing, series activity, manufacturing process, activity, action object, action means, action resources, by-product and work-in-process, and the relationship between these items, are shown. Each item represents a type of object.

The term “object” means an operable concept. This conceptual object model not only defines the above-mentioned part and other materials as resources, but also defines the time as a resource, and sets forth the relationship between them. The model shown in FIG. 1 is a more specific model using the above-mentioned model as an achieved form.

The term “series products” not only means a series product, but also includes, for example, various series products such as the series product P and the series product A as described above. The mark * represents a “many” or “wildcard” relationship (including however 0 and 1) (for example, the action resource and the resource occupation in FIG. 5 are in a 1 vs. many relationship). The notation “0 . . . 1” means 0 or 1. The subset of action resources is an action object or action means (i.e., the action resource is the general term of the action object and the action means). The subset of the action object is the series product or the work-in-process. The action means comprises equipment or skill. And the term “resource occupation” is a concept representing the extent of occupation of particular resources (parts used for action, quantity thereof, processing time, etc.) by an activity. The relationship between an activity and parts used by the activity is therefore defined by the resource occupation, and the quantity and the time prescribed in the resource occupation are set in advance.

The manufacturing process and the work-in-process are called the derived objects. The derived object is an object derived from the relationship with another object. In FIG. 5, the manufacturing process of a product means a sequenced set prepared by retrieving activities for materializing the attribute values of that product, detecting an attribute type representing the type of each attribute value therefrom, and changing the sequence of the retrieved activities on the basis of the relationship between the attribute type and the series activity and the sequential relationship between the series activity and the series manufacturing. In this connection, it is noted that FIG. 1 is a materialization of FIG. 5 (without showing in detail the relationship between the attribute type and the series activity or the sequential relationship between the series activity and the series manufacturing). Basically, the series manufacturing and the manufacturing process are in a relationship between a type and the instance which is the substance thereof, as between the attribute type and the attribute value, or between the series activity and the activity. In the present description, however, the relationship of the series manufacturing and the manufacturing process is clearly derived from the series manufacturing, the manufacturing process and the series product. These are not described as a direct relationship so as to avoid redundancy and to eliminate the necessity to consider consistency with the product group.

Explosion of parts of a product is accomplished as follows. Data of parts used in the individual activities for manufacturing a product are obtained from the resource occupation associated with the activities which are members of the manufacturing process of the product. Then, the action resources and action object are scanned on the basis of the data to find products corresponding to these parts from among the series product. Then, a manufacturing process of the product is derived using the method described above. By recursively repeating this, it is possible to retrieve all the parts composing the product and to then produce the product. In this connection, it is pointed out that the differences in explosion of parts between FIGS. 1 and 5 are caused by the difference in expressing means of the model, and FIGS. 1 and 5 may be considered to explode parts by the same method.

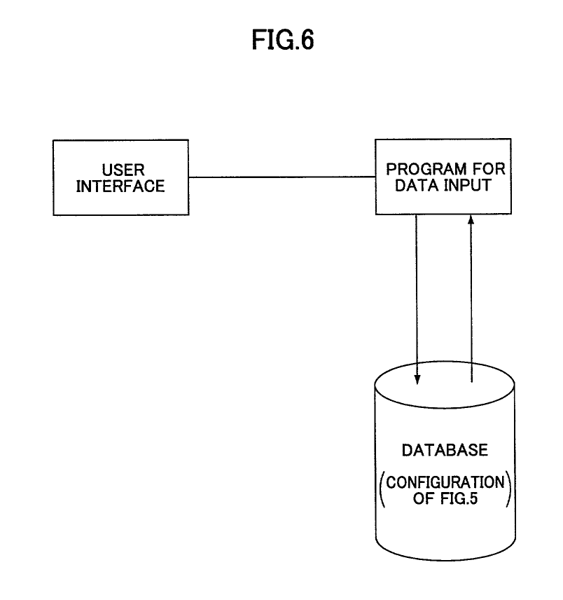

FIG. 6 illustrates a schematic block diagram of a user interface and program for inputting data into a database having the configuration set forth in FIG. 5. As shown in FIG. 6, data is entered through the user interface and is input into the database having the configuration set forth in FIG. 5 by a program for data input.

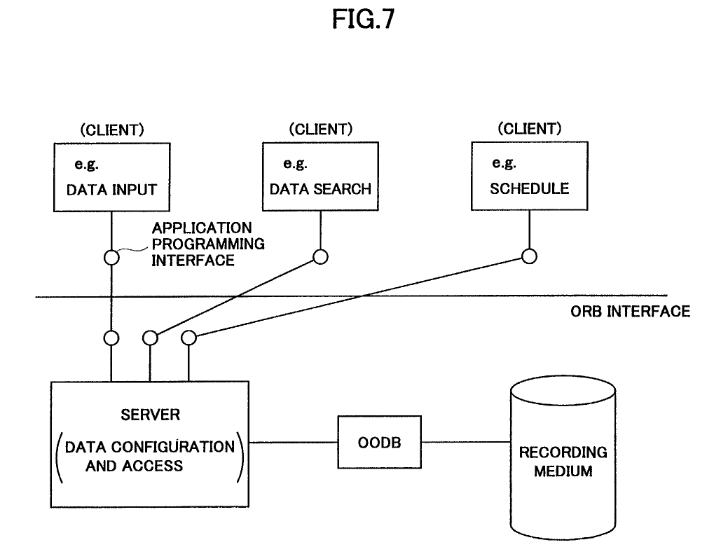

FIG. 7 illustrates a schematic block diagram of a manufacturing engineering information management system according to the invention. The database configuration shown in FIG. 5 is illustrated under the ORB (Object Request Broker) interface, and the data are stored in a recording medium through the OODB (Object Oriented Data Base). A server is provided for achieving data configuration and access, and a plurality of clients may access the data through the API (Application Programming Interface) using the ORB. For example, when a client desires to input data, the data is input by the user to the server via the API using the ORB, and is then stored in the recording medium via the OODB. In the same way, when a client desires to carry out a data search operation, the user searches for desired data by accessing the data recorded in the recording medium through the server. And finally, a scheduling operation can also be effected in a similar manner.

In the present invention, as described above, a product is represented by attribute values. It is therefore possible to cope with a difference in product not caused by a part, such as a difference caused by an activity. Even for a similar product caused by a slight difference, it is therefore possible to reduce the volume of redundant data of the component part information and to easily carry out maintenance operations, thus permitting improvement of reliability and degree of utilization. Further, because component part information and manufacturing routing information is comprehensively managed, it is possible to retrieve similar products and similar manufacturing processes, and find reusable manufacturing engineering information and to easily work out a new development plan. It is therefore possible to conduct small-quantity multiple-type production, and to develop and manufacture particular products in response to the demand of the market, while at the same time preventing excessive diversification. It is also possible to easily accomplish product development by comprehensively taking account of both r sources represented by the quantity of component parts and resources represented by the time required by the corresponding action means, and to thereby improve productivity.

What is claimed is:

1. A method of constructing a database for managing manufacturing engineering information comprising:
defining a set of products having a collection of attributes of use which are arbitrarily predetermined as a series product; and
defining each product contained in said series product by a collection of values of said attributes of use.

2. The method according to claim 1, wherein all of the products of the series product have common specifications.

3. The method according to claim 1, wherein the attributes of use include at least one of shape, grain, and function.

4. The method according to claim 1, wherein each different one of the products of the series product is defined by having a different value for at least one of said attributes of use.

5. The method according to claim 1, wherein the products of the series product have a number of different attributes of use within a range from 10 to 20.

6. The method according to claim 1, further comprising:
setting manufacturing series activities for achieving particular values of the individual attributes of use; and
deriving a manufacturing process for a particular product of the series product by arranging said manufacturing series activities in a prescribed sequence.

7. The method according to claim 6, wherein when at least one of the attribute values of the particular product is left undetermined, the manufacturing process is derived using a default value with respect to the at least one undetermined attribute value.

8. The method according to claim 6, wherein said series activities include at least one of welding, polishing and assembling.

9. The method according to claim 6, wherein parts to be used in the manufacturing process are determined in accordance with the set series activities.

10. The method according to claim 6, further comprising:
deriving a manufacturing process for a new product from parts used in the series activities; and
carrying out retrieval of the parts recursively.

11. The method according to claim 6, wherein works-in-process produced by the series activities are not registered.

12. The method according to claim 6, wherein works-in-process produced by the series activities are automatically synthesized.

13. A method of constructing a database for managing manufacturing engineering information comprising:
representing a by-product using a set of values of attributes of use, said by-product being produced by manufacturing series activities and excluding works-in-process produced by said manufacturing series activities; and
managing the by-product as a product.

14. A recording medium having stored thereon a computer program for constructing a database for managing manufacturing engineering information, said computer program comprising:
program code means for enabling a computer to define a set of products having a collection of attributes of use which are arbitrarily predetermined as a series product; and
program code means for defining each product contained in said series product by a collection of values of said attributes of use.

15. A manufacturing engineering information management system comprising:
attribute value storing means storing values of attributes of use which are arbitrarily predetermined, and a set of products having a collection of said attributes of use;
activity storing means for storing activities which may be applied to achieve said values of said attributes of use, as well as time and physical resource data required by said activities; and
manufacturing engineering information management means for managing a manufacturing process of a particular product of the set of products based on said stored activities, and for managing parts or manufacturing steps of said particular product based on said stored time and physical resource data required for said activities.
